(19) United States
(12) Patent Application Publication
(10) Pub. No.: US 2012/0056731 A1
(43) Pub. Date: Mar. 8, 2012

(54) DEVICE CONTROL SYSTEM

(75) Inventor: Ryoichi Okabe, Kawagoe-shi (JP)

(73) Assignee: PIONEER CORPORATION, Kanagawa (JP)

(21) Appl. No.: 13/264,478

(22) PCT Filed: Apr. 16, 2009
(86) PCT No.: PCT/JP2009/057640

§ 371 Date: Nov. 15, 2011

(51) Int. Cl. G05B 11/01

(52) U.S. Cl. 340/12.52

(57) ABSTRACT

A controller 20 includes means that communicates, as need arises, with each of other controllers 20 and players 10 to create a device list representing that each of the other controllers 20 and the players 10 is operative; means that communicates, as need arises, with each of the players 10 to create a controller list representing that each of the players 10 is lastly controlled by which of the controllers 20; means that refers to, when receiving a first control instruction to control a player 10A, the device list and the controller list to determine whether an other controller whose control instruction conflicting with the control instruction is present in the other controllers; means that creates, when it is determined that conflicted controller is present in the other controllers, information indicative of whether to approve or disapprove the first control instruction, and sends the created third information to the conflicted controller; and means that controls the first target device in accordance with the first control instruction when receiving reply information representing that the first control instruction is approved.

### TECHNICAL FIELD OF THE INVENTION

The present invention relates to technologies in a device control system equipped with a plurality of controllers that can control each of a plurality of target device, these technologies solve contention in which the plurality of controllers send control instructions to a same target device.

### BACKGROUND ART

Recently, environments in which DLNA (Digital Living Network Alliance) certified devices, such as AV devices, personal computers, home information appliances, and so on can be connected with each other via a home LAN (home network), have been provided.

In such an environment, using an integrated remote controller in which individual remote-control functions are integrated allows each device to be uniformly controlled remotely. However, if users in a home try to control various devices using respective integrated remote controllers, they may send control instructions to a same device, resulting in control-instruction contention.

In this viewpoint, patent document 1 discloses a technology that has set priorities for solving control-instruction contention, and solves the control-instruction contention in accordance with the set priorities.

### CITATION LIST

### Patent Document

Patent document 1: Japanese Patent Laid-Open No. 2001-346276

### DISCLOSURE OF THE INVENTION

### Problems to be Solved by the Invention

It is a good idea to solve control-instruction contention using the technology disclosed in the patent document 1. It is another idea to solve control-instruction contention by confirming intentions of the users respectively sending the control instructions.

The present invention has been made to solve the aforementioned circumstances, and has an example of a purpose of providing device control systems, which are capable of preventing, when a plurality of controllers send respective control instructions to a same target device, contention between the control instructions by reflecting intentions of users that respectively send the control instructions.

### Means for Solving the Problems

In order to achieve such a purpose provided above, one aspect of the present invention is a device control system including a plurality of target devices to be controlled; and a plurality of controllers that remotely control the plurality of target devices. Each of the plurality of controllers includes: an input means that receives an operation of a user as a control instruction; a display means that displays information associated with the control instruction; a communication means communicable with each of the plurality of target devices and each of the other plurality of controllers; a first information obtaining means that communicates, as need arises, with each of the target devices and each of the other plurality of controllers to obtain first information via the communication means, the first information representing that each of the target devices is operative and each of the other plurality of controllers is operative; a second information obtaining means that communicates, as need arises, with each of the target devices to obtain second information via the communication means, the second information representing that each of the target devices is lastly controlled by which of the plurality of controllers; a determining means that refers to, when receiving a first control instruction to control a first target device in the plurality of control devices via the input means, the first information and the second information to determine whether an other controller whose control instruction conflicting with the control instruction is present in the other controllers; a third information sending means that creates, when the determining means determines that a conflicted controller is present in the other controllers, third information indicative of a content of the first control instruction, and sends the created third information to the conflicted controller via the communication means; and a device control means that controls the first target device in accordance with the first control instruction when receiving, from the conflicted controller, reply information via the communication means, the reply information representing that the first control instruction is approved.

### BRIEF DESCRIPTION OF THE DRAWINGS

FIG. 1 is a schematic structural view of a device control system according to the first embodiment of the present invention;

FIG. 2 is a functional structural view of a network audio player of the device control system according to the first embodiment of the present invention;

FIG. 3 is a functional structural view of a controller of the device control system according to the first embodiment of the present invention;

FIG. 4 is an example of screen images to be displayed on a display unit of a controller of the device control system according to the first embodiment of the present invention;

FIG. 5 is a flowchart illustrating a device-list creating task in a controller of the device control system according to the first embodiment of the present invention;

FIG. 6 is an example of a device list of a controller of the device control system according to the first embodiment of the present invention;

FIG. 7 is a flowchart illustrating a controller-list creating task in a controller of the device control system according to the first embodiment of the present invention;

FIG. 8 is an example of a controller list of a controller of the device control system according to the first embodiment of the present invention;

FIG. 9 is a flowchart illustrating a network audio player control task in a controller of the device control system according to the first embodiment of the present invention;

FIG. 10 is an example of a message to be sent from a controller of the device control system according to the first embodiment of the present invention to another controller;

FIG. 11 is a flowchart illustrating a subsequent-message receiving task of the device control system according to the first embodiment of the present invention;

FIG. 12 is an example of a screen window when a controller of the device control system according to the first embodiment of the present invention receives a subsequent control instruction;

FIG. 13 is a functional structural view of a controller of a device control system according to the second embodiment of the present invention;

FIG. 14 is an example of a waiting list of a controller of the device control system according to the second embodiment of the present invention;

FIG. 15 is a flowchart illustrating a part of a network audio player control task in a controller of the device control system according to the second embodiment of the present invention;

FIG. 16 is a flowchart illustrating a part of a subsequent-message receiving task of the device control system according to the second embodiment of the present invention;

FIG. 17 is a functional structural view of a controller of a device control system according to the third embodiment of the present invention;

FIG. 18 is an example of an abandonment list of a controller of the device control system according to the third embodiment of the present invention; and

FIG. 19 is a flowchart illustrating an abandonment-list creating task in a controller of the device control system according to the third embodiment of the present invention; and

FIG. 20 is a flowchart illustrating a part of a network audio player control task in a controller of the device control system according to the third embodiment of the present invention.

### EMBODIMENTS FOR CARRYING OUT THE INVENTION

Embodiments of the present invention will be described hereinafter with reference to the drawings.

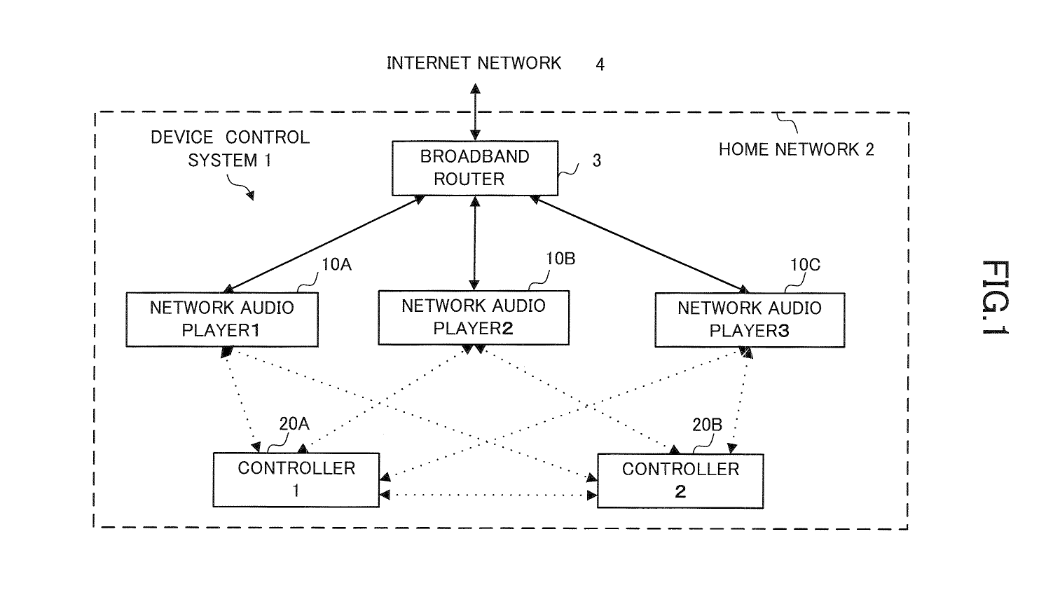

FIG. 1 is a schematic structural view of a device control system 1 according to the first embodiment of the present invention. The device control system 1 illustrated in FIG. 1 is a device control system constructed in a home network (home LAN) 2. The device control system 1 includes a plurality of network audio players 10 for playing back music contents, and a plurality of controllers 20 for controlling the plurality of network audio player 10.

A network audio player 10 is a music player that supports an internet radio service and a client function of DLNA (Digital Living Network Alliance). In the first embodiment, as the plurality of audio players 10, three network audio players 10A, 10B, and 10C are provided. The network audio players 10A, 10B, and 10C are connected with each other via a broadband router 3, and connected with an internet network 4. Hereinafter, for describe a specific network audio player, it will be expressed as the network audio player 10A, 10B, or 10C, and for describe a network audio player generically, it will be expressed as a network audio player 10.

A controller 20 is a remote controller capable of remotely controlling each of the network audio players 10A, 10B, and 10C. In the first embodiment, as the plurality of controllers 20, two controllers 20A and 20B are provided. Hereinafter, for describe a specific controller, it will be expressed as the controller 20A or 20B, and for describe a controller generically, it will be expressed as a controller 20.

Note that the device control system 1 according to this embodiment is comprised of three network audio players 10 and two controllers 20, but the number of network audio players 10 and the number of controllers 20 are not limited to three. Specifically, the device control system can have any configuration as long as at least one network audio player 10 and a plurality of controllers 20 are provided, and control instructions from the controllers 20 for the at least one network audio players 10 can become contention. A target device to be controlled by a controller 20 is not limited to a network audio player 10, and can be any device as long as it can play back a predetermined content. For example, a target device to be controlled by a controller 20 can be a video player that can play back video contents.

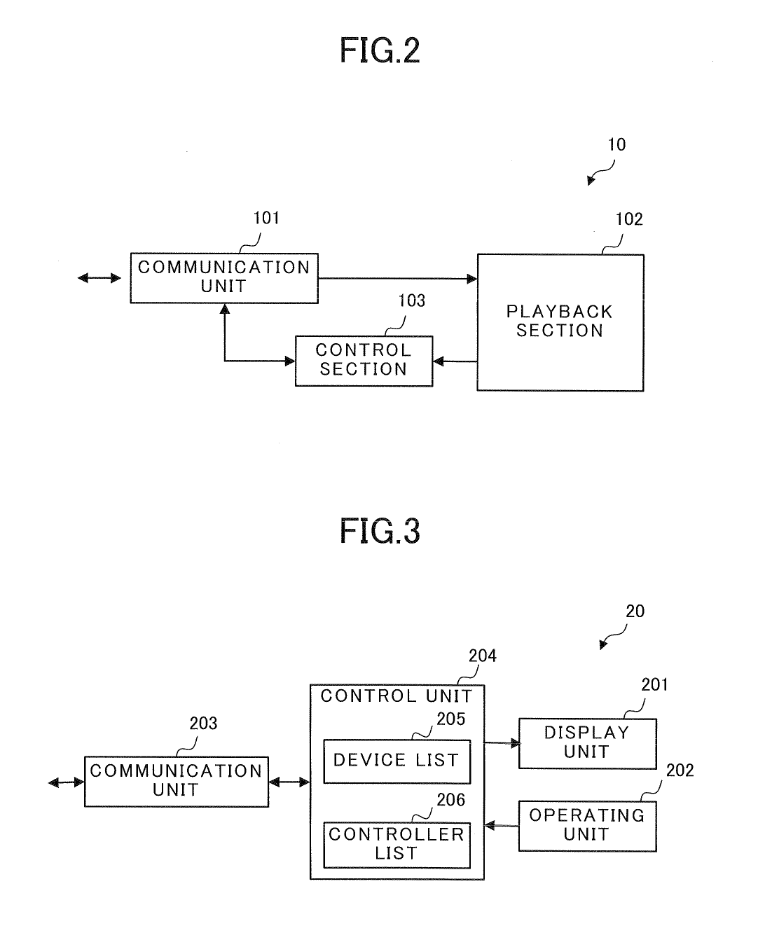

FIG. 2 is a functional structural view of a network audio player 10. A network audio player 10 is comprised of a communication unit 101, a playback unit 102, and a control unit 103. The communication unit 101 communicates with a controller 20, and obtains music data via the home network 2 or the Internet network 4. The playback unit 102 plays back music data. The control unit 103 carries out overall control of the corresponding network audio player 10.

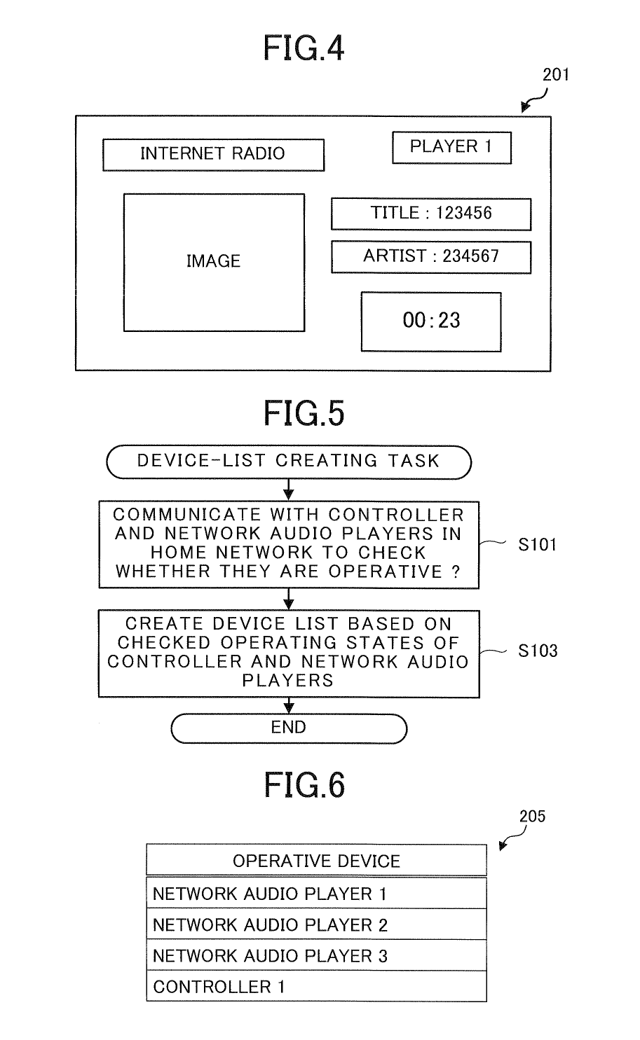

FIG. 3 is a functional structural view of a controller 20. A controller 20 is comprised of a display unit 201, an operating unit 202, a communication unit 203, and a control unit 204. The display unit 201 displays the name of a device, and the source and the meta-information of music being controlled in playback thereby, or the status in playback. The operating unit 202 consists of buttons and/or switches that accept user's operations. The communication unit 203 communicates with a network audio player 10 about information associated with contents of control, such as meta-information of music. The control unit 204 carries out overall control of the corresponding controller 20. FIG. 4 illustrates an example of screen images to be displayed on the display unit 201 of a controller 20. FIG. 4 shows contents of control when the network audio player 10A is being controlled. Specifically, FIG. 4 shows that the network audio player 10A is playing back a music content on the internet radio under control of the corresponding controller 20.

The control unit 204 is comprised of a CPU including at least computing functions and control functions, and a main memory consisting of, for example, a ROM and a RAM, which has a function of storing programs and data. The control unit 204 according to this embodiment includes a device list 205 and a controller list 206 stored in the main memory. Contents of each of the device list 205 and controller list 206 will be fully described later.

Next, operations of the device control system 1 will be described. First, let us describe a device-list creating task of a controller 20 of the device control system 1 for creating the device list 205 using FIG. 5. In this embodiment, each controller 20 (20A and 20B) runs the device-list creating task at regular time intervals T1 to create the device list 205, thus storing it therein.

First, one controller 20 communicates with the other controller 20 in the home network 2 and the network audio players 10 to thereby check whether the other controller 20 and the network audio players 10 are operative (specifically, are powered on) at present in step S101. For example, the controller 20A checks whether the controller 20B and the network audio players 10A, 10B, and 10C are active.

Next, the controller 20 creates the device list 205 based on the operating states of the checked other controller 20 and the network audio players 10 in step S103. The device list 205 is a list in which the other controller 20 and at least one network audio player 10, which are operative, are included. Specifically, the controller 20 determines that at least one of the other controller 20 and network audio players 10, which is communicable therewith, is operative, thus creating the device list 205.

FIG. 6 illustrates an example of the device list 205 created by the controller 20B. The device list 205 illustrated in FIG. 6 shows that all devices except for its own device in the home network 2, such as the network audio players 10A, 10B, and 10C, and the controller 10A are operative at present.

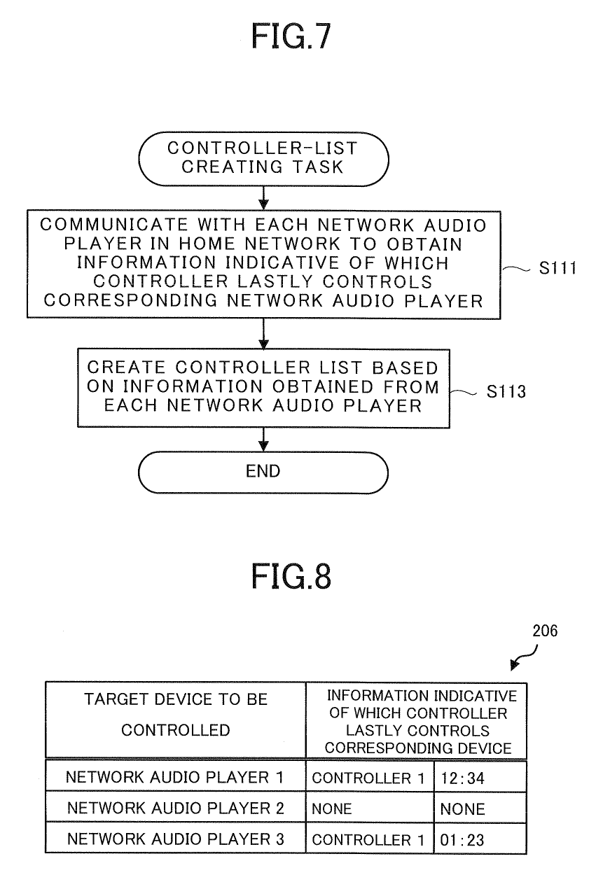

Next, let us describe a controller-list creating task of a controller 20 of the device control system 1 for creating the controller list 206 using FIG. 7. In this embodiment, each controller 20 (20A and 20B) runs the controller-list creating task at regular time intervals T2 to create the controller list 206, thus storing it therein.

First, one controller 20 communicates with each network audio player 10 in the home network 2 to thereby obtain, from each network audio player 10, information indicative of which controller 20 lastly controls a corresponding network audio player 10 in step S111. For example, the controller 20A obtains, from each of the network audio players 10A, 10B, and 10C, information indicative of which controller 20 lastly controls a corresponding network audio player 10.

Next, the controller 20 creates the controller list 206 based on the information obtained from each network audio player 10 in step S113.

FIG. 8 illustrates an example of the controller list 206 created by the controller 20B. The controller list 206 illustrated in FIG. 8 shows that, for each of the target devices to be controlled, such as each of the network audio players 10 in this embodiment, information indicative of the last controller 20 that lastly controls a corresponding network audio player 10. The information indicative of the last controller 20 that lastly controls a corresponding network audio player 10 according to this embodiment includes: the name of a corresponding controller 20, which is information for uniquely identifying a corresponding controller 20, and time at which a corresponding network audio player 10 is lastly controlled. The controller list 206 illustrated in FIG. 8 shows that the controller 20A lastly controls the network audio player 10A, and lastly controls the network audio player 10C.

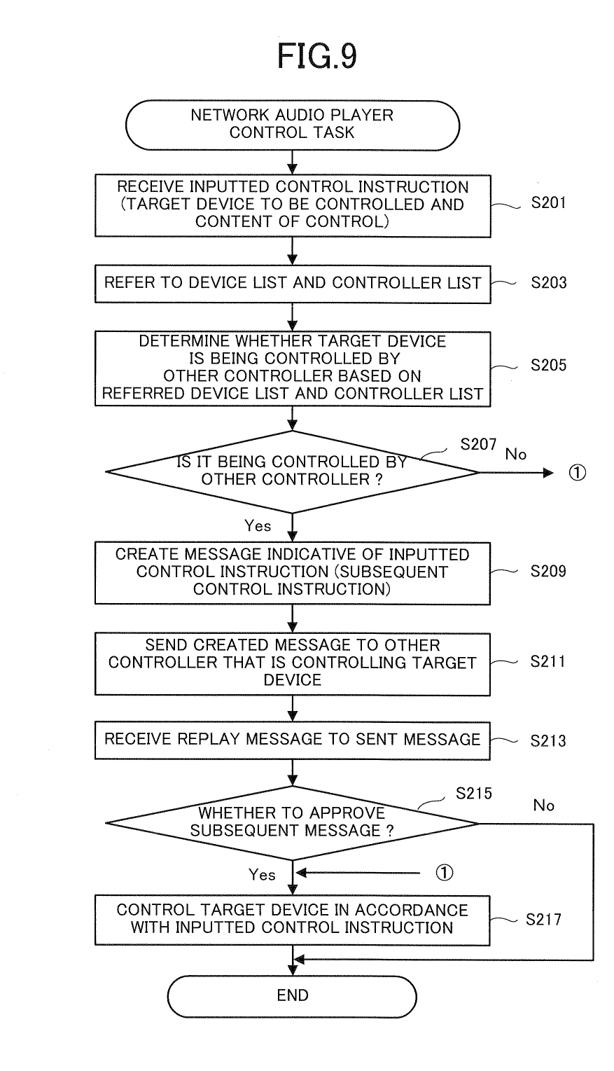

Next, let us describe a network audio player control task of a controller 20 for controlling a network audio player 10 using FIG. 9. The network audio player control task is executed each time a control instruction is inputted to the controller 20 by a user's operation via the operating unit 202 of the controller 20.

First, the controller 20 receives a control instruction inputted via the operating unit 202 in step S201. The control instruction is information indicative of how to control any network audio player 10, that is, information indicative of a target device to be controlled and contents of control therefor.

Next, the controller 20 refers to the device list 205 and the controller list 206 in step S203, and determines whether the target device in the control instruction is being controlled by the other controller 20 based on the referred device list 205 and controller list 206 in step S205. Specifically, if the target device in the control instruction is present in the device list 205 and the controller list 206 shows that the target device is lastly controlled by the other controller 20, it is determined that the target device is being controlled by the other controller 20. For example, if the controller 20B stores therein the device list 205 illustrated in FIG. 6 and the controller list 206 illustrated in FIG. 8, and receives a control instruction to control the network audio player 10A, it is determined that the network audio player 10A is under control of the controller 20A at present.

If the target device in the control instruction is being controlled by the other controller 20 (YES in step S207), the controller 20 creates a message including the contents of the inputted control instruction (hereinafter referred to as a “subsequent control instruction”) in step S209, and sends the created message to the other controller 20 that is controlling the target device in step S211. This operation is to show a user of the other controller 20 that the target device under control of the other controller 20 is in contention, and to ask the user to determine whether to approve the subsequent control instruction.

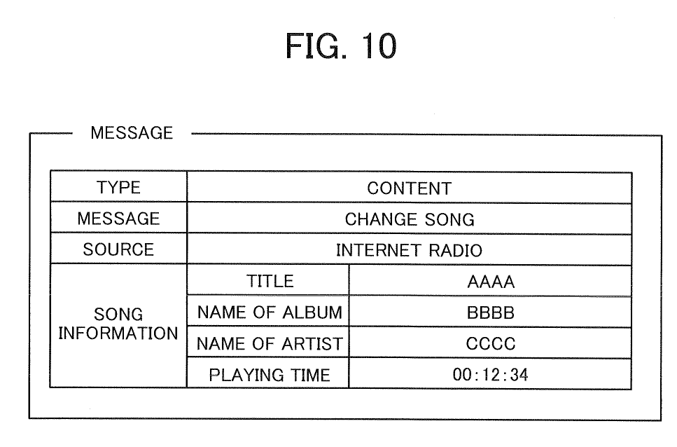

For example, the controller 20B receives a control instruction to control the network audio player 10A from a user. In this case, if it is determined that the network audio player 10A is being controlled by the controller 20A, the controller 20B sends, to the network audio player 10A, a message. FIG. 10 illustrates an example of the message to be sent from the controller 20B to the controller 20A. The message illustrated in FIG. 10 shows information to change a song being played back by the network audio player 10A, and information of a new song after the change.

Next, the controller 20 receives, from the other controller 20 to which the message has sent, a reply message to the sent message in step S213. Although the details will be described later, because the reply message includes information indicative of whether to approve the subsequent control instruction, if it is determined to approve the subsequent control instruction (YES in step S215), the controller 20 controls the target device in accordance with the inputted control instruction (subsequent control instruction) in step S217. In contrast, if it is determined to disapprove the subsequent control instruction (NO in step S215), the controller 20 terminates the task without executing the subsequent instruction.

Note that, in step S207, If the target device in the control instruction is not being controlled by the other controller 20 (NO in step S207), the controller 20 controls the target device in accordance with the inputted control instruction (subsequent control instruction) in step S217.

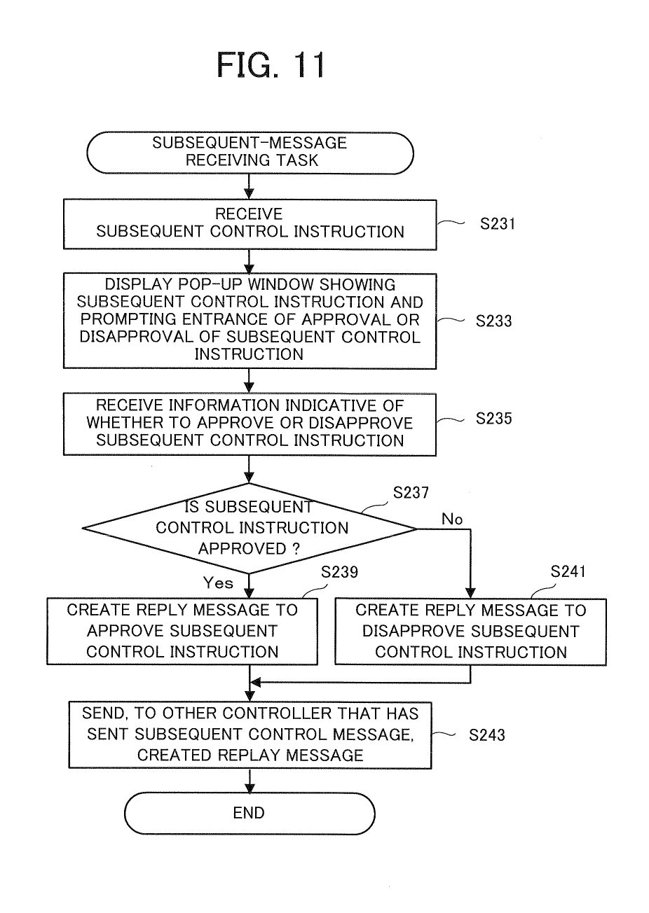

Next, let us describe a subsequent-message receiving task of a controller 20 for receiving a message including a subsequent control instruction using FIG. 11. The subsequent-message receiving task is executed each time a subsequent control instruction is inputted to the controller 20.

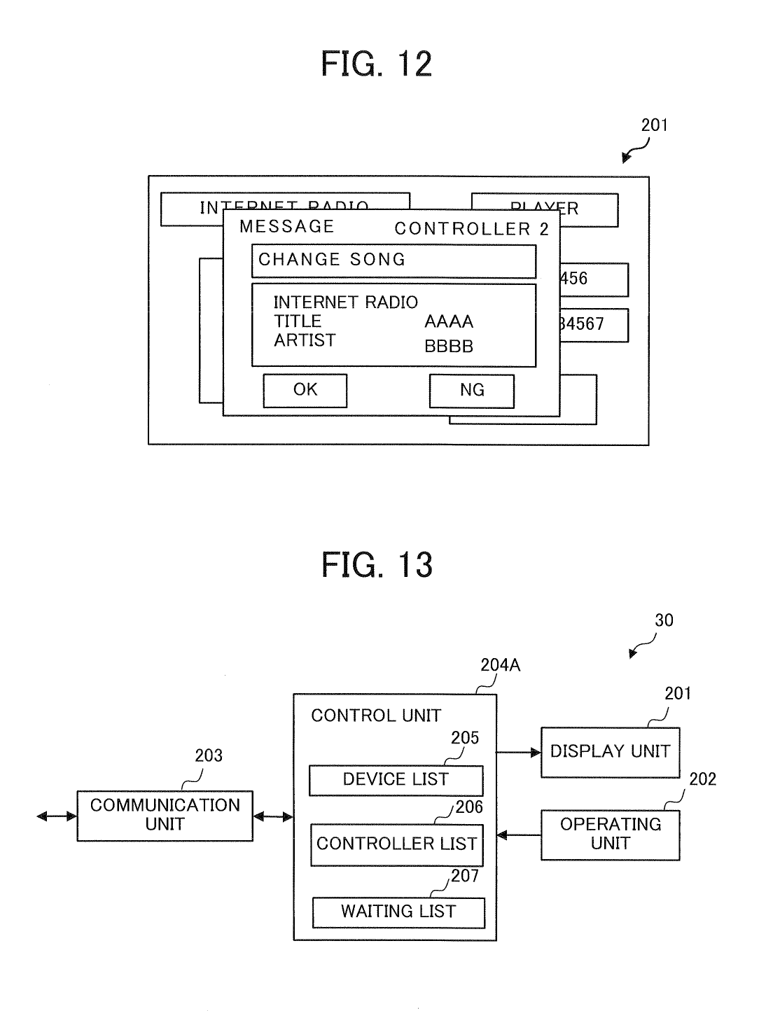

When receiving the message including the subsequent control instruction in step S231, the controller 20 displays a pop-up window showing the subsequent control instruction and prompting entrance of approval or disapproval of the subsequent control instruction in step S233. FIG. 12 illustrates an example of the pop-up window. FIG. 12 illustrates the pop-up window that the controller 20A displays on the display unit 201 when the controller 20B sends a message illustrated in FIG. 10 to the controller 20B. In this case, on the display unit 201 of the controller 20A, the pop-up window is displayed; the pop-up window includes the message representing change of a song being played back by the network audio player 10A, and prompts entrance of approval or disapproval of change of the song.

Based on a user's operation to approve change of the song or disapprove it, the controller 20 receives information indicative of whether to approve the subsequent control instruction via the operating unit 202 in step S235. For example, in order to approve change of the song on the pop-up window illustrated in FIG. 12, a button “OK” is selected so that information indicative of approval of change of the song is inputted. In contrast, in order to disapproval change of the song, a button “NG” is selected so that information indicative of disapproval of change of the song is inputted.

Upon determining to approve the subsequent control instruction (YES in step S237), the controller 20 creates a reply message to approve the subsequent control instruction in step S239. Otherwise, upon determining to disapprove the subsequent control instruction (NO in step S237), the controller 20 creates a reply message to disapprove the subsequent control instruction in step S241.

Next, the controller 20 sends, to the other controller 20 that has sent the message, the created reply message in step S243.

As described above, because the device control system 1 according to this embodiment is configured such that each controller 20 creates the device list 205 and the controller list 206 as need arises, whether there is contention between control instructions to a target device to be controlled can be properly grasped. If there is contention between the control instructions to the target device, the device control system 1 sends, to a controller 20 conflicting with an alternative controller 20, a message including contents of the control instruction, and receives a reply message of whether to approve or disapprove the control instruction. When receiving the reply message to approve the control instruction, the device control system 1 executes the control instruction to the target device. When receiving the reply message to disapprove the control instruction, the device control system 1 does not execute the control instruction to the target device. Thus, even if control a plurality of controllers individually send instructions to a same target device to be controlled, it is possible to prevent contention between the control instructions by reflecting intentions of users that respectively send the control instructions being conflicted with each other.

Specifically, if there is contention between control instructions to a target device to be controlled, a later user, which sends the control instruction to the target device subsequent to the sending of the control instruction to the target device by a former user, informs the alternative user of contents of the control instruction, thus sounding the former user about change of the control instruction. The former user informs the later user of reply of whether to approve or disapprove the change of the control instruction. Thus, it is possible to prevent contention between the control instructions by reflecting intentions of the users.

Next, a device control system 1A according to the second embodiment will be described.

FIG. 13 is a schematic structural view of a controller 30 of the device control system 1A. A control unit 204A of the controller 30 includes, in addition to the structure of the control unit 204 according to the first embodiment, a waiting list 207. Note that, hereinafter, structural elements, functions, and processes, which are different from those of the first embodiment, will be only described, and therefore, like structural elements, like functions, and like processes, to which like reference characters are assigned, are omitted in description.

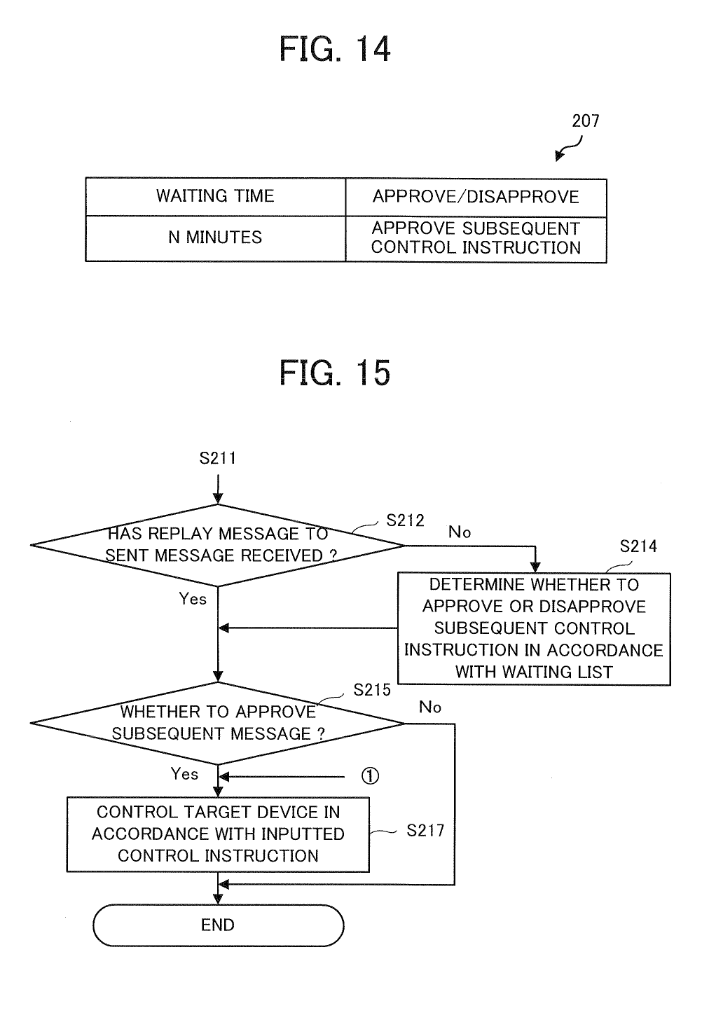

The waiting list 207 is a list showing that, if a corresponding controller 30 does not receive a reply message irrespective of sending a message including the subsequent control instruction, how to handle the subsequent control instruction. FIG. 14 illustrates an example of the waiting list 207. The waiting list 207 illustrated in FIG. 14 consists of waiting time and flag information indicative of whether to approve a subsequent control instruction. For example, the waiting list 207 illustrated in FIG. 14 approves the subsequent control instruction if it has not received a reply message for N minutes since the sending of a corresponding message.

FIG. 15 is a flowchart illustrating a part of a network audio player control task according to the second embodiment.

A controller 20 determines, after having sent a message to the other controller 20, whether it has received a reply message from the other controller 20 in step S212. Specifically, the controller 20 determines whether it has received a reply message within the waiting time stored in the waiting list 207 since the sending of the corresponding message.

Upon determining that the controller 20 has received the reply message (YES in step S212), because the reply message includes information indicative of whether to approve or disapprove the subsequent control message, the controller 20 determines whether to approve or disapprove the subsequent control instruction in step S215. Upon determining to approve the subsequent control instruction (YES in step S215), the controller 20 controls the target device in accordance with the inputted control instruction (subsequent control instruction) in step S217. Otherwise, upon determining to disapprove the subsequent control instruction (NO in step S215), the controller 20 terminates the task without executing the subsequent instruction.

Upon determining that the controller 20 has not received the reply message (NO in step S212), the controller 20 refers to the flag information stored in the waiting list 207 to thereby determine whether to approve or disapprove the subsequent control instruction in step S214. Upon determining to approve the subsequent control instruction (YES in step S215), the controller 20 controls the target device in accordance with the inputted control instruction (subsequent control instruction) in step S217. Otherwise, upon determining to disapprove the subsequent control instruction (NO in step S215), the controller 20 terminates the task without executing the subsequent instruction.

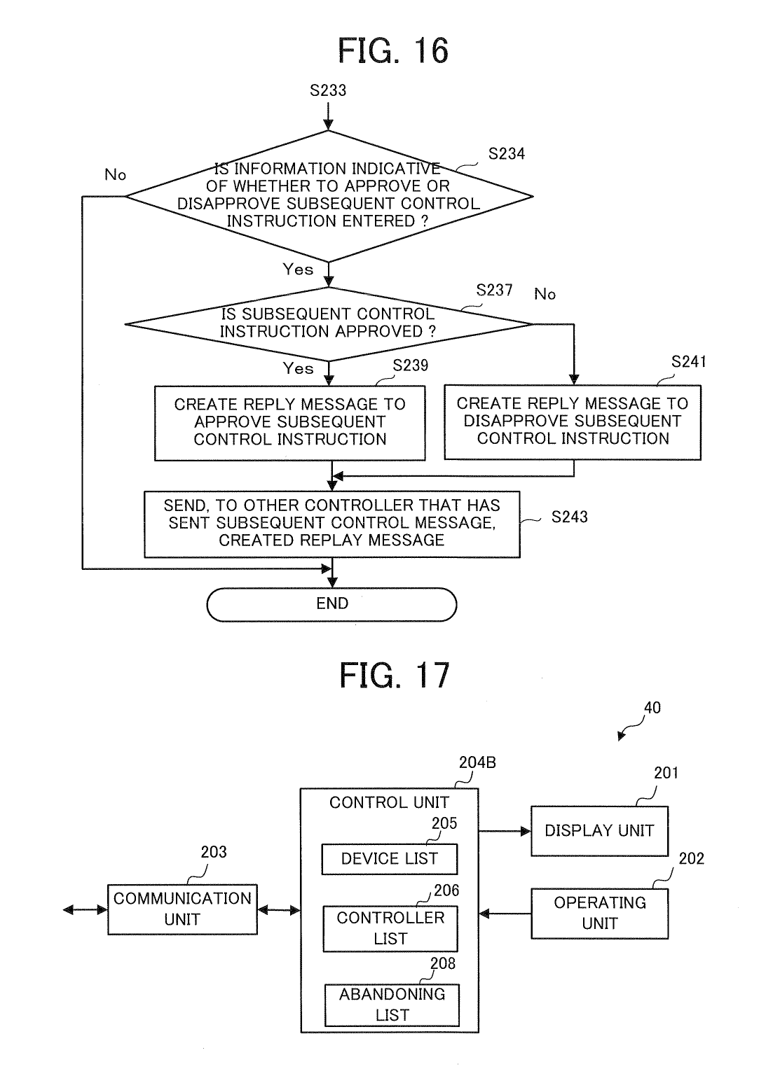

FIG. 16 is a flowchart illustrating a part of a subsequent-message receiving task according to the second embodiment.

A controller 20 determines whether information indicative of whether to approve the subsequent control instruction is entered via the operating unit 202 in step S234.

Upon determining that the information indicative of whether to approve the subsequent control instruction is inputted (YES in step S234), and determining to approve the subsequent control instruction (YES in step S237), the controller 20 creates a reply message to approve the subsequent control instruction in step S239. Otherwise, upon determining to disapprove the subsequent control instruction (NO in step S237), the controller 20 creates a reply message to disapprove the subsequent control instruction in step S241.

Next, the controller 20 sends, to the other controller 20 that has sent the message, the created reply message in step S243.

Otherwise, upon determining that the information indicative of whether to approve the subsequent control instruction is not entered (NO in step S234), the controller 20 terminates the task.

As described above, the device control system 1A is capable of determining whether to approve or disapprove execution of a subsequent control instruction even if it does not receive a reply message from an alternative controller to which a corresponding message has been sent. Thus, in addition to the advantages according to the first embodiment, it is possible to prevent contention between control instructions without checking intentions of users that use corresponding controllers under which target devices are controlled.

Next, a device control system 1C according to the third embodiment will be described.

FIG. 17 is a schematic structural view of a controller 40 of the device control system 1B. A control unit 204B of the controller 40 includes, in addition to the structure of the control unit 204 according to the first embodiment, an abandonment list 208.

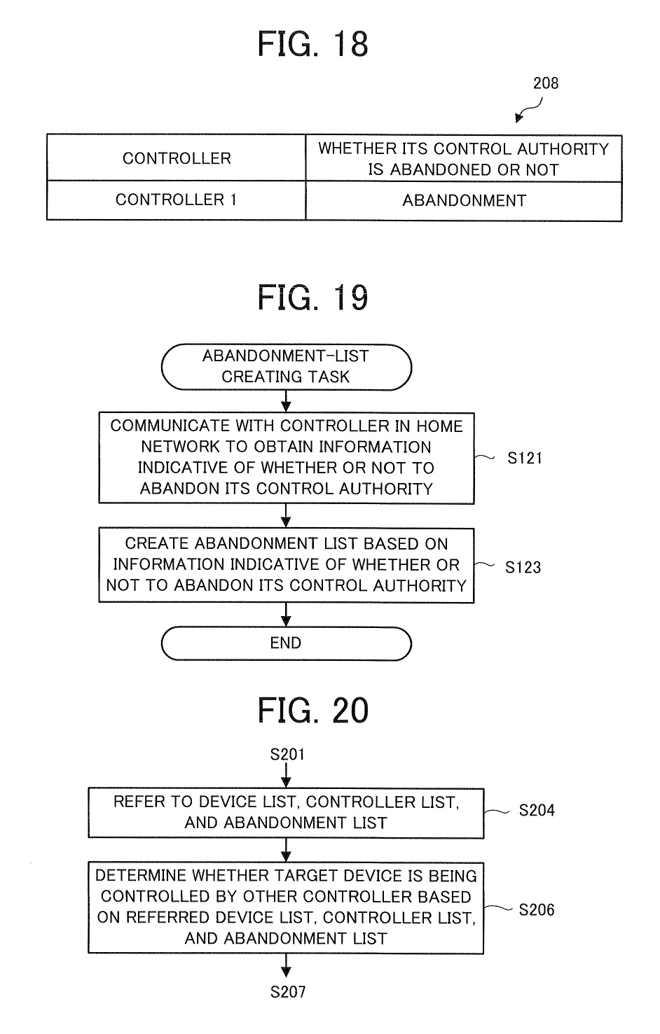

The abandonment list 208 is a list showing whether or not to abandon control of a target device. FIG. 18 illustrates an example of the abandonment list 208. The abandonment list 208 illustrated in FIG. 18 consists of flag information indicative of whether, for each controller, to abandon a corresponding target device. For example, the controller 20A abandons control of a corresponding target device. Note that the flag information indicative of whether or not to abandon control of a corresponding target device is set by a user that uses its own controller 20 via the operating unit 202 into its own controller 20. For example, if a user cannot control a target device for a preset period because he or she is away from the target device, abandonment of control of the target device is set. This reflects, even if to send a reply message is difficult because of no users around a controller 20, the intention of a user for the controller 20.

FIG. 19 is a flowchart illustrating an abandonment-list creating task according to the third embodiment. In this embodiment, each controller 20 (20A and 20B) runs the abandoning-list creating task at regular time intervals T3 to create the abandonment list 208, thus storing it therein.

First, one controller 20 communicates with the other controller 20 in the home network 2 to thereby obtain the flag information stored in the other controller 20; this flag information represents whether or not to abandon the other controller's control authority in step S121. For example, the controller 20B obtains, from the controller 20A, the flag information indicative of whether or not to abandon its control authority.

Next, the controller 20 creates the abandonment list 208 based on the flag information indicative of whether or not to abandon its control authority in step S123.

FIG. 20 is a flowchart illustrating a part of a network audio player control task according to the third embodiment.

A controller 20 receives a control instruction inputted via the operating unit 202 in step S201. The control instruction is information indicative of how to control any network audio player 10, that is, information indicative of a target device to be controlled and contents of control therefor.

Next, the controller 20 refers to the device list 205, the controller list 206, and the abandonment list 208 in step S204, and determines whether the target device in the control instruction is being controlled by the other controller 20 based on the referred device list 205, controller list 206, and abandonment list 208 in step S206. Specifically, if the target device in the control instruction is present in the device list 205, the controller list 206 shows that the target device is lastly controlled by the other controller 20, and the other controller 20 does not abandon control the target device, it is determined that the target device is being controlled by the other controller 20. In other words, even if the target device is present in the device list 205 and is lastly controlled by the other controller 20, when the other controller 20 abandons control of the target device, it is determined that the target device in the control instruction is being controlled by the other controller 20 at present.

As described above, the device control system 1B according to this embodiment is capable of preventing contention between control instructions by reflecting an intention of a user that abandons his/her control authority in addition to the advantages according to the first embodiment.

Note that the controller 30 according to the second embodiment is provided with the waiting list 207, and the controller 40 according to the third embodiment is provided with the abandonment list 208, but each controller can be provided with both of the waiting list 207 and abandonment list 208.

In each of these embodiments, while contention between control instructions to control a same target device is described, contention between control instructions to simultaneously control a plurality of target devices can be similarly described. For example, if the controller 20B sends a control instruction to each of the network audio players 10A and 10B while the network audio players 10A and 10B are under control of the controller 20A, it can be configured to send, to the controller 20A, a message including the control instruction for the network audio player 10A and a message including the control instruction for the network audio player 10B.

Because each controller according to each of these embodiments can grasp that each target device is under control of which controller, it is possible to display at least one target device that is not under control of any controller.

In each of these embodiments, when sending individual control instructions to a same target device, a plurality of controllers communicate messages with each other in order to determine any one of the plurality of controllers that controls the target device, but the present invention can be applied to another use. For example, it can be applied to a case where a user A recommends a song to a user B. In this case, a message associated with the recommended song is sent from a controller used by the user A to a controller B used by the user B, and the user B can see the message to thereby determine whether to play back the recommended song.

### DESCRIPTION OF CHARACTERS

1 Device control system

2 Home network

3 Broadband router

4 Internet network

10, 10A, 10B, 10C Network audio player

20, 20A, 20B, 30, 40 Controller

101, 203 Communication unit

102 Playback unit

103, 204, 204A, 204B Control unit

201 Display unit

202 Operating unit

205 Device list

206 Controller list

207 Waiting list

208 Abandonment list

1. A device control system comprising:
a plurality of target devices to be controlled; and
a plurality of controllers that remotely control the plurality of target devices,
wherein each of the plurality of controllers comprises:
an input means that receives an operation of a user as a control instruction;
a display means that displays information associated with the control instruction;
a communication means communicable with each of the plurality of target devices and each of the other plurality of controllers;
a first information obtaining means that communicates with each of the target devices and each of the other plurality of controllers to obtain first information via the communication means, the first information representing that each of the target devices is operative and each of the other plurality of controllers is operative;
a second information obtaining means that communicates with each of the target devices to obtain second information via the communication means, the second information representing that each of the target devices is lastly controlled by which of the plurality of controllers;
a determining means that refers to, when receiving a first control instruction to control a first target device in the plurality of target devices via the input means, the first information and the second information to determine whether an other controller whose control instruction conflicting with the first control instruction is present in the other controllers;
a third information sending means that creates, when the determining means determines that an other controller is present in the other controllers as a conflicted controller, third information indicative of operational information of the first control instruction, and sends the created third information to the conflicted controller via the communication means;
a device control means that controls the first target device in accordance with the first control instruction when receiving, from the conflicted controller, reply information via the communication means, the reply information representing that the first control instruction is approved;
an output control means that displays, when receiving the third information from an other controller via the communication means, operational information represented by the third information on the display means;
a first input control means that receives, as the reply information, information representing whether to approve or disapprove the first control instruction and inputted via the input means; and
a reply information sending means that sends, via the communication means, the reply information to the other controller that has sent the third information.

2. (canceled)

3. The device control system according to claim 1, wherein, during the third information being displayed on the display means, the output control means indicates, by sound or vibration, that the third information is displayed on the display means.

4. The device control system according to claim 1, wherein, when the first target device is operative based on the first information and the first target device is lastly controlled by the other controller based on the second information, the determining means determines that Ran the first control instruction conflicts with the control instruction of the other controller.

5. The device control system according to claim 1, wherein the device control means controls the first target device when the determining means determines that an other controller is not present in the other controllers.

6. The device control system according to claim 1, wherein, when the device control means does not receive, from the conflicted controller via the communication means, the reply information to the first control instruction, the device control means determines whether to control the first target device in addition to a predetermined waiting condition.

7. The device control system according to claim 1, wherein each of the plurality of controllers comprises:
a second input control means that receives, as fourth information, information representing whether to abandon control of the target device and inputted via the input means; and
a fourth information sending means that sends, via the communication means as need arises, the fourth information to the other plurality of controllers, and
wherein, when receiving the first control instruction via the input means, the determining means refers to the first information, the second information, and the fourth information to determine whether an other controller whose control instruction conflicting with the first control instruction is present in the other controllers.
